(19) United States
(12) Patent Application Publication
(10) Pub. No.: US 2025/0373807 A1
(43) Pub. Date: Dec. 4, 2025

(54) CROSS-COMPONENT RESIDUAL PREDICTION ON CHROMA SIGNALING AND INTRATMP MODE

(71) Applicant: Tencent America LLC, Palo Alto, CA (US)

(72) Inventors: Lien-fei CHEN, Palo Alto, CA (US); Roman CHERNYAK, Santa Clara, CA (US); Madhu PERINGASSERY KRISHNAN, Mountain View, CA (US); Xin ZHAO, San Jose, CA (US); Xiaozhong XU, State College, PA (US); Shan LIU, San Jose, CA (US)

(73) Assignee: Tencent America LLC, Palo Alto, CA (US)

(21) Appl. No.: 19/299,294

(22) Filed: Aug. 13, 2025

Related U.S. Application Data
(63) Continuation of application No. PCT/US2024/025605, filed on Apr. 20, 2024.
(60) Provisional application No. 63/461,224, filed on Apr. 21, 2023.

(51) Int. Cl. H04N 19/132; H04N 19/176; H04N 19/186; H04N 19/46

(52) U.S. Cl. CPC H04N 19/132; H04N 19/176; H04N 19/186; H04N 19/46

(57) ABSTRACT

An apparatus of video decoding is provided. The apparatus includes processing circuitry. The processing circuitry is configured to receive a video bitstream for a current block. The video bitstream includes flag information when (i) intra template matching prediction (intraTMP) is applied to both a luma component and a chroma component of the current block or (ii) a luma coded block flag indicates that the luma component of the current block is associated with zero transform coefficients. The flag information indicates whether cross-component residual model (CCRM) is applied to the current block. When the flag information indicates that the CCRM is applied to the current block, the processing circuitry is configured to reconstruct chroma samples of the chroma component of the current block based on reconstructed luma samples of the luma component of the current block.

### INCORPORATION BY REFERENCE

The present application is a continuation of International Application No. PCT/US2024/025605, filed on Apr. 20, 2024, which claims the benefit of priority to U.S. Provisional Application No. 63/461,224, “CROSS-COMPONENT RESIDUAL PREDICTION ON CHROMA SIGNALING AND INTRATMP MODE” filed on Apr. 21, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of processing visual media data is provided. In the method, a bitstream of the visual media data including a current picture is processed according to a format rule. The bitstream includes coded information of a current block in the current picture, where the current block includes a luma component and a chroma component. The format rule specifies that the bitstream includes a flag indicating whether cross-component residual model (CCRM) is applied to the current block when (i) intra template matching prediction (intraTMP) is applied to both the luma component and the chroma component of the current block, the chroma component and the luma component of the current block are in a single tree structure, and a block vector (BV) of the chroma component is derived from a BV of the luma component or (ii) a luma coded block flag indicates that the luma component of the current block is associated with zero transform coefficients. When the flag indicates that the CCRM is applied to the current block, the format rule specifies that chroma samples of the chroma component of the current block are processed based on reconstructed luma samples of the luma component of the current block.

In an example, the bitstream further includes a first syntax element indicating whether the CCRM is applied to a Cb component of the chroma component and a second syntax element indicating whether the CCRM is applied to a Cr component of the chroma component.

In an example, the format rule specifies that filters are derived based on prediction samples of the Cb component, prediction samples of the Cr component, and prediction samples of the luma component. The format rule specifies that the filters are applied to the reconstructed luma samples of the luma component to generate filtered samples of the luma component. The format rule specifies that samples of the Cb component are reconstructed based on a sum of the filtered samples of the luma component and a residual of the Cb component and samples of the Cr component are reconstructed based on a sum of the filtered samples of the luma component and a residual of the Cr component.

In an example, the format rule specifies that, when filter coefficients of the filters are not derivable for the Cb component, the samples of the Cb component are reconstructed based on a sum of the prediction samples of the Cb component and the residual of the Cb component.

In an example, the format rule specifies that, when filter coefficients of the filters are not derivable for the Cr component, the samples of the Cr component are reconstructed based on a sum of the prediction samples of the Cr component and the residual of the Cr component.

In an example, the format rule specifies that transform syntax information is received after the flag information is received in the bitstream, where the transform syntax information indicates a transformation kernel and a quantization parameter for the current block.

According to another aspect of the disclosure, a method of video encoding is provided. In the method, when (i) intraTMP is applied to both a luma component and a chroma component of a current block or (ii) the luma component of the current block is associated with zero transform coefficients, whether CCRM is applied to the current block is determined. When the CCRM is determined to be applied to the current block, chroma samples of the chroma component of the current block are encoded in a video bitstream based on reconstructed luma samples of the luma component of the current block. Flag information is further encoded in the video bitstream. The flag information includes a first syntax element that indicates whether the CCRM is applied to a Cb component of the chroma component and a second syntax element that indicates whether the CCRM is applied to a Cr component of the chroma component.

In an example, whether the CCRM is applied to the current block is determined when the intraTMP is applied to both the luma component and the chroma component of the current block, the chroma component and the luma component of the current block are in a single tree structure, and a block vector (BV) of the chroma component is derived from a BV of the luma component.

In an example, to encode the chroma samples of the chroma component, filters are derived based on prediction samples of the Cb component, prediction samples of the Cr component, and prediction samples of the luma component. The filters are applied to the reconstructed luma samples of the luma component to generate filtered samples of the luma component. Reconstructed samples of the Ch component are determined based on a sum of the filtered samples of the luma component and a residual of the Cb component. Reconstructed samples of the Cr component are determined based on a sum of the filtered samples of the luma component and a residual of the Cr component.

In an example, when filter coefficients of the filters are not derivable for the Cb component, the reconstructed samples of the Cb component are determined based on a sum of the prediction samples of the Cb component and the residual of the Cb component.

In an example, when filter coefficients of the filters are not derivable for the Cr component, the reconstructed samples of the Cr component are determined based on a sum of the prediction samples of the Cr component and the residual of the Cr component.

According to yet another aspect of the disclosure, an apparatus for video decoding is provided. The apparatus includes processing circuitry. The processing circuitry is configured to receive a video bitstream for a current block. The video bitstream includes flag information when (i) intraTMP is applied to both a luma component and a chroma component of the current block or (ii) a Cbf indicates that the luma component of the current block is associated with zero transform coefficients. The flag information indicates whether CCRM is applied to the current block. When the flag information indicates that the CCRM is applied to the current block, the processing circuitry is configured to reconstruct chroma samples of the chroma component of the current block based on reconstructed luma samples of the luma component of the current block.

In an example, the video bitstream includes the flag information when the intraTMP is applied to both the luma component and the chroma component of the current block, the chroma component and the luma component of the current block are in a single tree structure, and a block vector (BV) of the chroma component is derived from a BV of the luma component.

In an example, the flag information further includes a first syntax element indicating whether the CCRM is applied to a Cb component of the chroma component and a second syntax element indicating whether the CCRM is applied to a Cr component of the chroma component.

In an example, the processing circuitry is configured to derive filters based on prediction samples of the Cb component, prediction samples of the Cr component, and prediction samples of the luma component. The processing circuitry is configured to apply the filters to the reconstructed luma samples of the luma component to generate filtered samples of the luma component. The processing circuitry is configured to reconstruct (i) samples of the Cb component based on a sum of the filtered samples of the luma component and a residual of the Cb component and (ii) samples of the Cr component based on a sum of the filtered samples of the luma component and a residual of the Cr component.

In an example, the processing circuitry is configured to, when filter coefficients of the filters are not derivable for the Cb component, reconstruct the samples of the Cb component based on a sum of the prediction samples of the Cb component and the residual of the Cb component.

In an example, the processing circuitry is configured to, when filter coefficients of the filters are not derivable for the Cr component, reconstruct the samples of the Cr component based on a sum of the prediction samples of the Cr component and the residual of the Cr component.

In an example, the processing circuitry is configured to receive transform syntax information after the flag information is received in the video bitstream, where the transform syntax information indicates a transformation kernel and a quantization parameter for the current block.

In an example, the flag information includes a respective flag for each of a plurality of subblocks of the current block to indicate if the CCRM is applied to the respective subblock.

In an example, the flag information further indicates whether the CCRM is applied to each of a plurality of subblocks of the current block.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an intra template matching prediction (IntraTMP) according to some aspects of the disclosure.

FIG. 5 is a schematic illustration of a cross-component residual model (CCRM) according to some aspects of the disclosure.

FIG. 6 is a schematic illustration of a calculation of filter coefficients in CCRM according to some aspects of the disclosure.

FIG. 7 shows a flow chart outlining a decoding process according to some aspects of the disclosure.

FIG. 8 shows a flow chart outlining an encoding process according to some aspects of the disclosure.

FIG. 9 is a schematic illustration of a computer system in accordance with an aspect.

### DETAILED DESCRIPTION

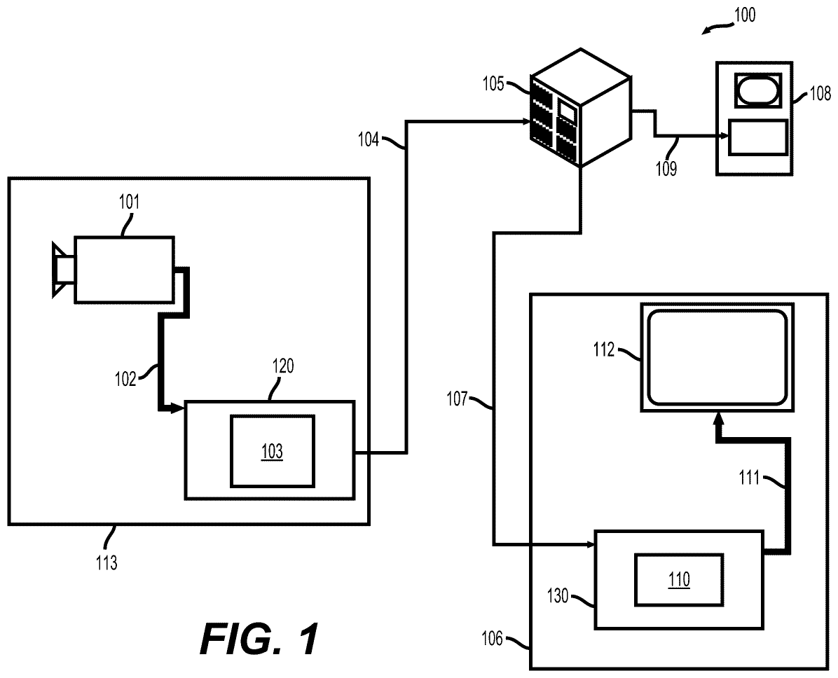

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

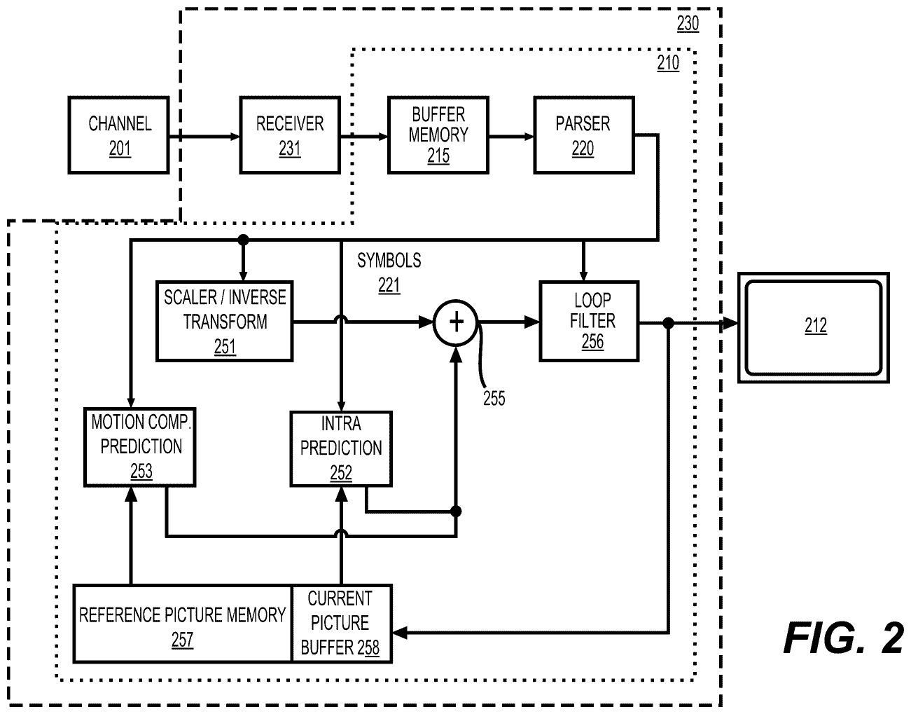

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

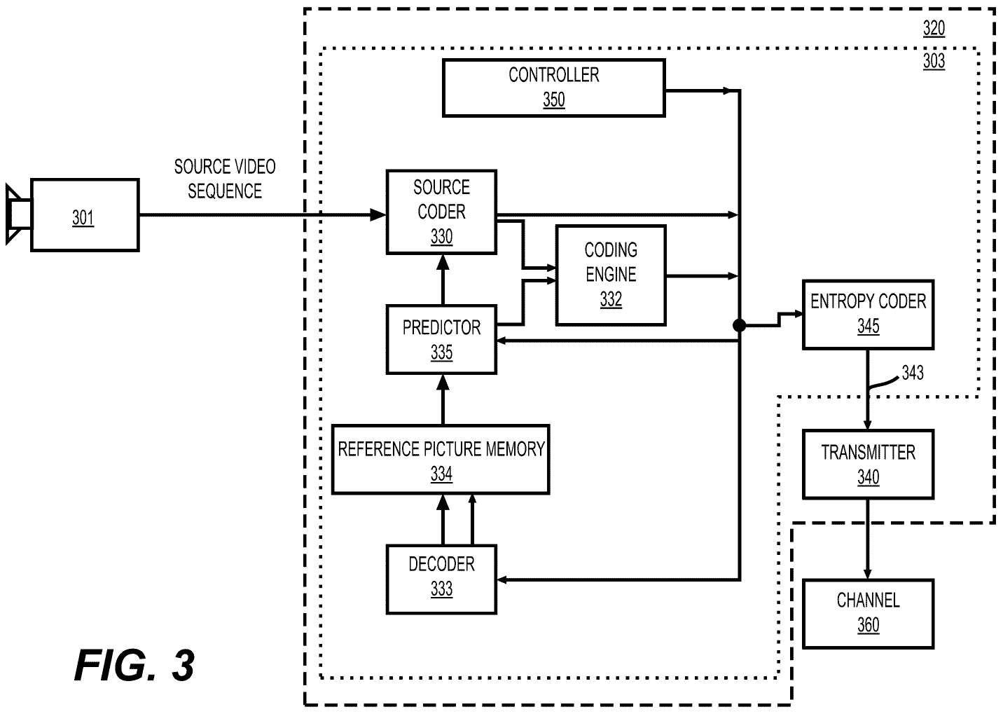

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include techniques for improving local illumination compensation.

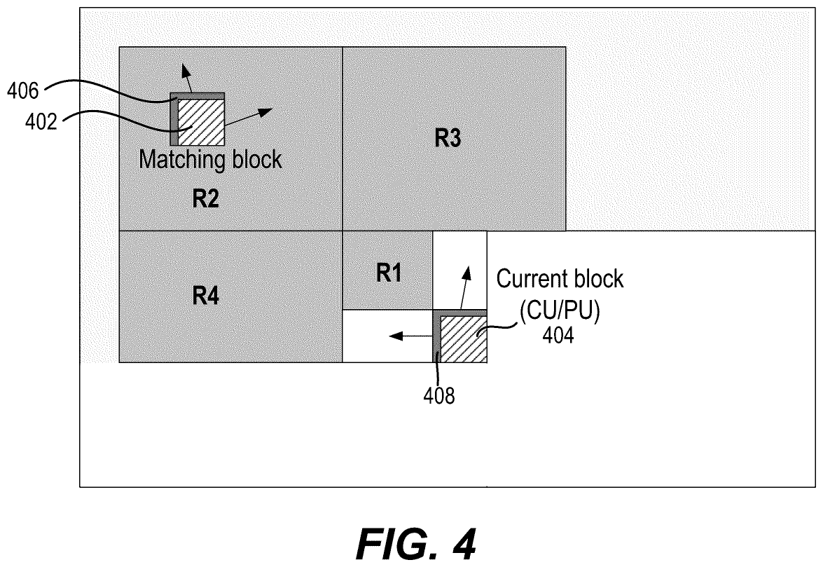

Intra template matching prediction (also referred to as intraTMP) is, for example, a special intra prediction mode that copies a best prediction block from the reconstructed part of the current frame, whose L-shaped template matches the current template (e.g., a template of a current block). For a predefined search range, the encoder may search for a most similar template to the current template in a reconstructed part of the current frame and uses the corresponding block as a prediction block, where the most similar template is associated with the corresponding block and the current template is associated with the current block. The encoder then signals the usage of the intraTMP mode, and the same prediction operation can be performed at a decoder side. A matching block (or corresponding block) (402) can be illustrated in FIG. 4 and act as the matching area for a current CU (404).

As shown in FIG. 4, the prediction signal may be generated by matching the L-shaped causal neighbors (or L-shaped template) of the current block (404) with another block in a predefined search area. An example predefined search area may include R1 (a current CTU), R2 (a top-left CTU), R3 (an above CTU), and R4 (a left CTU).

In an aspect, a sum of absolute differences (SAD) is used as a cost function in IntraTMP mode. Within each search area, the decoder can search for a template (406) of a block (402) that has a least SAD with respect to the current template (408) of the current block (404) and use the block with the least SAD as a corresponding block of the current block. The corresponding block may further act as a prediction block for the current block (404).

Dimensions of all search regions (e.g., SearchRange_w, SearchRange_h) may be set proportional to a block dimension (e.g., BlkW, BlkH) of the current block. Accordingly, a fixed number of SAD comparisons may be obtained in each pixel. For example, the dimensions of a search region (or search range) may be defined in Equations 1 and 2 as follows:

$$SearchRange\_w = a * BlkW \qquad Eq . ( 1 )$$

$$SearchRange\_h = a * BlkH \qquad Eq . ( 2 )$$

where “a” is a constant that controls a trade-off between a gain and a complexity of the search process. In an example, “a” is equal to 5.

In an aspect, to speed-up the template matching process, the search range of all search regions may subsampled by a factor of 2. The reduced search range may lead to a reduction of template matching search by 4. After a best match is found, a refinement process may be further performed. The refinement may be performed via a second template matching search around the best match with a reduced range. The reduced range may be defined as min (BlkW, BlkH)/2.

The Intra template matching tool may be enabled for CUs with a size less than or equal to 64 in a width and a height. A maximum CU size for Intra template matching may be configurable.

In an aspect, the intra template matching prediction mode may signaled at a CU level through a dedicated flag when decoder-side intra mode derivation (DIMD) is not used for a current CU.

In an aspect, such as in ECM, intraTMP may be a special intra prediction mode for a luma component. In an example, a flag may be signaled as one of a plurality of chroma prediction modes. However, the flag syntax may have redundancy when intraTMP mode is activated in a single tree structure. In addition, when a luma component and a chroma component use different BVs, potential subjective quality artifact may exist, such as color bleeding. In an example, a flag is signaled to indicate whether intraTMP is applied or not at a coded block unit or a prediction block unit for both of a luma component and a chroma component in a single tree structure. For a separate tree structure (e.g., a dual tree structure), the signaled flag may indicate whether intraTMP is applied or not for the coded luma component or the coded chroma component, and intraTMP may be applied to both of Cb and Cr of the chroma component when the coded component is a chroma channel when intraTMP mode is selected.

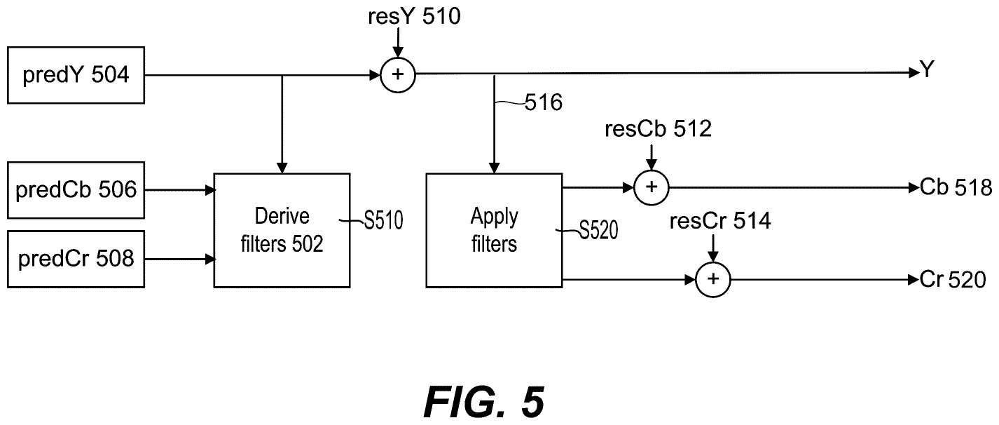

In an aspect, such as in JVET-AD0108, a cross-component residual model (CCRM) is proposed to predict chroma samples of a block from reconstructed luma samples of the block when the block uses inter prediction or intra block copy (IBC). FIG. 5 illustrates a decoder side of the CCRM method. As shown in FIG. 5, cross-component filters (502) may be derived at step (S510) using prediction signals of luma and chroma, such as predY (504), predCb (506), and predCr (508). The derived filters may be applied at step (S520) to a reconstructed luma signal (516) to produce final chroma predictions that include a Cb component (518) and a Cr component (520). The reconstructed luma signal may be determined as a sum of the prediction signal of luma (e.g., predY (504)) and residual data of luma (e.g., res Y (510)). The Cb (518) may be determined as a sum of a filtered luma signal generated at the step (S520) and residual data of Cb (e.g., resCb (512)). The Cr (520) may be determined as a sum of the filtered luma signal generated at the step (S520) and residual date of Cr (e.g., resCr (514)).

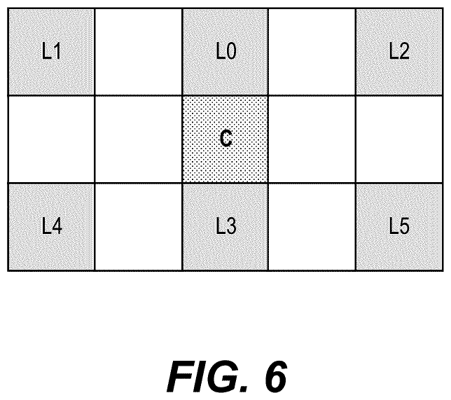

In an aspect, as shown in FIG. 6, an 8-tap filter may be applied to CCRM that may include 6 spatial luma samples L0-L5, a nonlinear term, and a bias term. The spatial luma samples (e.g., L0, . . . , and L5) may be obtained from a luma grid by selecting the 6 luma samples L0-L5 closest to a chroma position C without down sampling. A predicted chroma value may be obtained in equation (3) as follow:

$$predChromaVal = {c}_{0} L 0 + {c}_{1} L 1 + {c}_{2} L 2 + {c}_{3} L 3 + {c}_{4} L 4 + {c}_{5} L 5 + {c}_{6} nonlinear ( L 0 + L 3 + 1 ) >> 1 ) + {c}_{7} B \qquad Eq . ( 3 )$$

where nonlinear ( ) is a nonlinear operator, such as a nonlinear operator of convolutional cross-component model (CCCM), and B is a bias. In an example, the nonlinear operator in equation (3) can be defined as follows in equation (4):

$$Nonlinear ( C ) = ( C * C + midVal ) >> bitDepth \qquad Eq . ( 4 )$$

where C is a center luma sample.

Still referring to FIG. 6, the filter coefficients may be derived using a division-free Gaussian elimination method and necessary offsets may be applied to samples prior to the filter derivation. Intra reference samples may be used as additional input samples in the filter derivation when the block has less than 64 chroma samples. In an example, a filter design of CCCM may include at most 6 rows and columns of intra reference samples. Thus, blocks having 256 chroma samples or more may be divided into subblocks that have at most 256 chroma samples. Subblocks containing a zero luma residual may be skipped. Usage of the CCRM mode may be signalled as a CABAC coded TU level flag. A new CABAC context may be included to support signaling of the flag. The CCRM flag may only be signalled if luma CBf of a TU (or transform unit) is non-zero and a prediction mode of the CU is either an inter prediction mode (e.g., MODE_INTER) or IBC mode (e.g., MODE_IBC).

CCRM may be applied to predict chroma samples from reconstructed luma samples of a coded block when the coded block is coded by and inter prediction or an intra block copy (IBC). However, relative improvement on IntraTMP based on CCRM was not provided. Moreover, flexibility (or other options) may be needed to determine whether the CCRM is applied or not.

In an aspect, CCRM may be applied for intraTMP. In an example, a flag may be signaled to indicate whether the CCRM is used or not when a coded block is coded in intraTMP mode.

In an example, a flag (or flag information) may be signaled to indicate whether CCRM is used or not when a chroma component and a luma component of a block are in a single tree structure, an intraTMP flag for both the luma component and the chroma component are enabled, and a BV (e.g., BV of IntraTMP) of the chroma component is derived from a BV of the luma component.

In an example, a flag may be signaled to indicate whether CCRM is used or not when an intraTMP flag of a coded block is enabled for both a luma component and a chroma component that are in a single tree structure. The intraTMP flag may indicate whether intraTMP is applied to the luma component and the chroma component of the coded block.

In an aspect, CCRM for an inter prediction block or an intra copy block (IBC) when a luma Cbf (or coded block flag) of a coded block is false. The Cbf may indicate whether residual data of a luma component of the coded block exist. When the luma Cbf is false, the luma Cbf may indicate that the residual data of the luma component is not available. For example, when the luma Cbf is a predefined value, such as false, the luma component of the current block is associated with zero transform coefficients.

In an aspect, CCRM may be applied to a Cb component and a Cr component independently. In an example, two flags (or a first syntax element and a second syntax element) may be signaled to indicate whether CCRM is applied to the Cb component and the Cr component or not, respectively.

In an aspect, a flag may be signaled to indicate whether CCRM is applied or not for chroma components (e.g., a Cb component and a Cr component). When the flag is true (e.g., CCRM is applied) and filter coefficients of filters (e.g., filters (502)) cannot be derived for one of the Cb component and the Cr component, a predictor of an inter prediction or an IBC may be used as a filtering output for the one of the Cb component and the Cr component for which the filter coefficients are not derived.

In an example, as shown in FIG. 5, a flag of CCRM may be enabled (e.g., CCRM is applied) and filter coefficients of the filters (502) for a Cb component are not derivable, the predCb (506) may be used as an output after the filters (502) are applied to the Cb component (518). Thus, when the filter coefficients of the filters (502) are not derived for the Cb component, the Cb component may reconstructed based on the predCb (506) and the resCb (512).

In an example, as shown in FIG. 5, a flag of CCRM is enabled and filter coefficients of the filters (502) for a Cr component are not derivable, the predCr (508) may be used as an output after the filters (502) are applied for the Cr component (520). Thus, when the filter coefficients of the filters (502) are not derived for the Cr component, the Cr component may be reconstructed based on the predCr (508) and the resCr (514).

In an aspect, a CCRM flag may be signaled no matter whether a luma Cbf is true or not. Thus, application of CCRM is independent of the luma Cbf.

In an example, the CCRM flag may be signaled before a transform unit syntax (or transform syntax information) associated with a block. The transform unit syntax may indicate a transform kernel and a quantization parameter that are applied to the block during a transformation process.

In an aspect, CCRM may be applied to subblock intraTMP. In sub-block intraTMP, a block may be partitioned into a plurality of subblocks. Each subblock of the block may be coded based on intraTMP.

In an example, a respective flag may be signaled for each subblock to indicate whether CCRM is used or not.

In an example, a flag may be signaled only at a block level to indicate whether all subblocks of a block use CCRM or not.

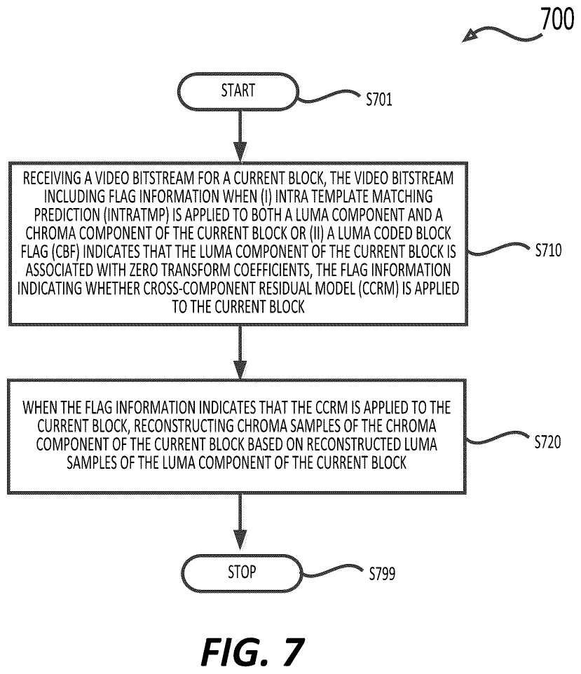

FIG. 7 shows a flow chart outlining a process (700) according to an aspect of the disclosure. The process (700) can be used in a video decoder. In various aspects, the process (700) is executed by processing circuitry, such as the processing circuitry that performs functions of the video decoder (110), the processing circuitry that performs functions of the video decoder (210), and the like. In some aspects, the process (700) is implemented in software instructions, thus when the processing circuitry executes the software instructions, the processing circuitry performs the process (700). The process starts at (S701) and proceeds to (S710).

At (S710), a video bitstream for a current block is received. The video bitstream includes flag information when (i) intra template matching prediction (intraTMP) is applied to both a luma component and a chroma component of the current block or (ii) a luma coded block flag (Cbf) indicates that the luma component of the current block is associated with zero transform coefficients. The flag information indicates whether cross-component residual model (CCRM) is applied to the current block.

At (S720), when the flag information indicates that the CCRM is applied to the current block, chroma samples of the chroma component of the current block are reconstructed based on reconstructed luma samples of the luma component of the current block.

In an example, the video bitstream includes the flag information when the intraTMP is applied to both the luma component and the chroma component of the current block, the chroma component and the luma component of the current block are in a single tree structure, and a block vector (BV) of the chroma component is derived from a BV of the luma component.

In an example, the flag information further includes a first syntax element indicating whether the CCRM is applied to a Cb component of the chroma component and a second syntax element indicating whether the CCRM is applied to a Cr component of the chroma component.

In an example, filters are derived based on prediction samples of the Cb component, prediction samples of the Cr component, and prediction samples of the luma component. The filters are applied to the reconstructed luma samples of the luma component to generate filtered samples of the luma component. Samples of the Cb component are reconstructed based on a sum of the filtered samples of the luma component and a residual of the Cb component. Samples of the Cr component are reconstructed based on a sum of the filtered samples of the luma component and a residual of the Cr component.

In an example, when filter coefficients of the filters are not derivable for the Cb component, the samples of the Cb component are reconstructed based on a sum of the prediction samples of the Cb component and the residual of the Cb component.

In an example, when filter coefficients of the filters are not derivable for the Cr component, the samples of the Cr component are reconstructed based on a sum of the prediction samples of the Cr component and the residual of the Cr component.

In an example, transform syntax information is received after the flag information is received in the video bitstream, where the transform syntax information indicates a transformation kernel and a quantization parameter for the current block.

In an example, the flag information includes a respective flag for each of a plurality of subblocks of the current block to indicate if the CCRM is applied to the respective subblock.

In an example, the flag information further indicates whether the CCRM is applied to each of a plurality of subblocks of the current block.

Then, the process proceeds to (S799) and terminates.

The process (700) can be suitably adapted. Step(s) in the process (700) can be modified and/or omitted. Additional step(s) can be added. Any suitable order of implementation can be used.

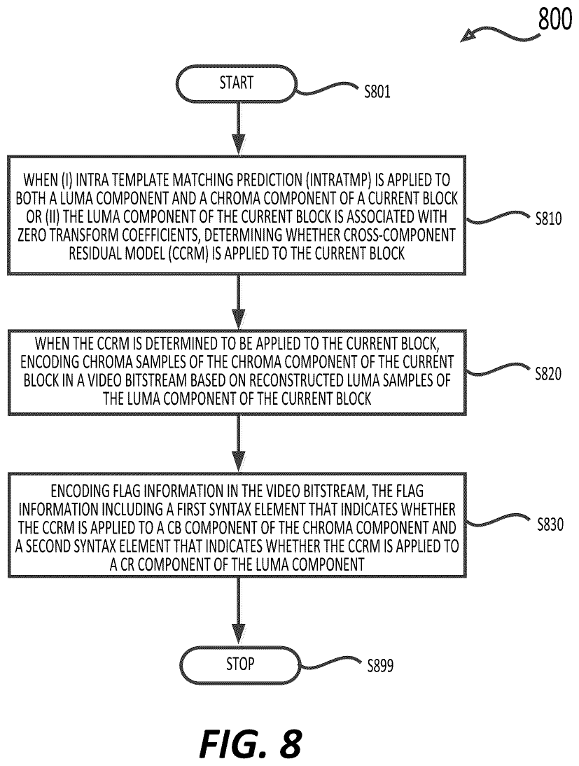

FIG. 8 shows a flow chart outlining a process (800) according to an aspect of the disclosure. The process (800) can be used in a video encoder. In various aspects, the process (800) is executed by processing circuitry, such as the processing circuitry that performs functions of the video encoder (103), the processing circuitry that performs functions of the video encoder (303), and the like. In some aspects, the process (800) is implemented in software instructions, thus when the processing circuitry executes the software instructions, the processing circuitry performs the process (800). The process starts at (S801) and proceeds to (S810).

At (S810), when (i) intraTMP is applied to both a luma component and a chroma component of a current block or (ii) the luma component of the current block is associated with zero transform coefficients, whether CCRM is applied to the current block is determined.

At (S820), when the CCRM is determined to be applied to the current block, chroma samples of the chroma component of the current block are encoded in a video bitstream based on reconstructed luma samples of the luma component of the current block.

At (S830), flag information is further encoded in the video bitstream. The flag information includes a first syntax element that indicates whether the CCRM is applied to a Cb component of the chroma component and a second syntax element that indicates whether the CCRM is applied to a Cr component of the chroma component.

In an example, whether the CCRM is applied to the current block is determined when the intraTMP is applied to both the luma component and the chroma component of the current block, the chroma component and the luma component of the current block are in a single tree structure, and a block vector (BV) of the chroma component is derived from a BV of the luma component.

In an example, to encode the chroma samples of the chroma component, filters are derived based on prediction samples of the Cb component, prediction samples of the Cr component, and prediction samples of the luma component. The filters are applied to the reconstructed luma samples of the luma component to generate filtered samples of the luma component. Reconstructed samples of the Cb component are determined based on a sum of the filtered samples of the luma component and a residual of the Cb component. Reconstructed samples of the Cr component are determined based on a sum of the filtered samples of the luma component and a residual of the Cr component.

In an example, when filter coefficients of the filters are not derivable for the Cb component, the reconstructed samples of the Cb component are determined based on a sum of the prediction samples of the Cb component and the residual of the Cb component.

In an example, when filter coefficients of the filters are not derivable for the Cr component, the reconstructed samples of the Cr component are determined based on a sum of the prediction samples of the Cr component and the residual of the Cr component.

Then, the process proceeds to (S899) and terminates.

The process (800) can be suitably adapted. Step(s) in the process (800) can be modified and/or omitted. Additional step(s) can be added. Any suitable order of implementation can be used.

According to an aspect of the disclosure, a method of processing visual media data is provided. In the method, a bitstream of the visual media data including a current picture is processed according to a format rule. For example, the bitstream may be the bitstream for any of the decoding/encoding methods. The format rule may specify constraints of the bitstream and/or processes to be performed by the decoder, and/or encoder.

In an example, the bitstream includes coded information of a current block in the current picture, where the current block includes a luma component and a chroma component. The format rule specifies that the bitstream includes a flag indicating whether cross-component residual model (CCRM) is applied to the current block when (i) intra template matching prediction (intraTMP) is applied to both the luma component and the chroma component of the current block or (ii) a luma coded block flag indicates that the luma component of the current block is associated with zero transform coefficients. When the flag indicates that the CCRM is applied to the current block, the format rule specifies that chroma samples of the chroma component of the current block are processed based on reconstructed luma samples of the luma component of the current block.

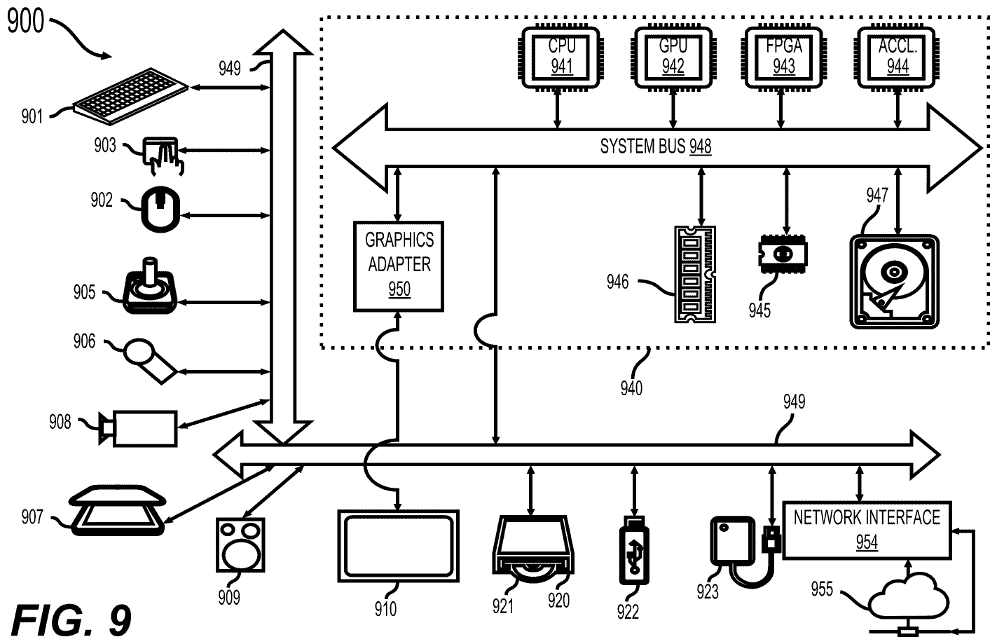

The techniques described above, can be implemented as computer software using computer-readable instructions and physically stored in one or more computer-readable media. For example, FIG. 9 shows a computer system (900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 9 for computer system (900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (900).

Computer system (900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (901), mouse (902), trackpad (903), touch screen (910), data-glove (not shown), joystick (905), microphone (906), scanner (907), camera (908).

Computer system (900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (910), data-glove (not shown), or joystick (905), but there can also be tactile feedback devices that do not serve as input devices), audio output devices (such as: speakers (909), headphones (not depicted)), visual output devices (such as screens (910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (900) can also include human accessible storage devices and their associated media such as optical media including CD/DVD ROM/RW (920) with CD/DVD or the like media (921), thumb-drive (922), removable hard drive or solid state drive (923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (900) can also include an interface (954) to one or more communication networks (955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (949) (such as, for example USB ports of the computer system (900)); others are commonly integrated into the core of the computer system (900) by attachment to a system bus as described below (for example Ethernet interface into a PC computer system or cellular network interface into a smartphone computer system). Using any of these networks, computer system (900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (940) of the computer system (900).

The core (940) can include one or more Central Processing Units (CPU) (941), Graphics Processing Units (GPU) (942), specialized programmable processing units in the form of Field Programmable Gate Areas (FPGA) (943), hardware accelerators for certain tasks (944), graphics adapters (950), and so forth. These devices, along with Read-only memory (ROM) (945), Random-access memory (946), internal mass storage such as internal non-user accessible hard drives, SSDs, and the like (947), may be connected through a system bus (948). In some computer systems, the system bus (948) can be accessible in the form of one or more physical plugs to enable extensions by additional CPUs, GPU, and the like. The peripheral devices can be attached either directly to the core's system bus (948), or through a peripheral bus (949). In an example, the screen (910) can be connected to the graphics adapter (950). Architectures for a peripheral bus include PCI, USB, and the like.

CPUs (941), GPUs (942), FPGAs (943), and accelerators (944) can execute certain instructions that, in combination, can make up the aforementioned computer code. That computer code can be stored in ROM (945) or RAM (946). Transitional data can also be stored in RAM (946), whereas permanent data can be stored for example, in the internal mass storage (947). Fast storage and retrieve to any of the memory devices can be enabled through the use of cache memory, that can be closely associated with one or more CPU (941), GPU (942), mass storage (947), ROM (945), RAM (946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (900), and specifically the core (940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (940) that are of non-transitory nature, such as core-internal mass storage (947) or ROM (945). The software implementing various aspects of the present disclosure can be stored in such devices and executed by core (940). A computer-readable medium can include one or more memory devices or chips, according to particular needs. The software can cause the core (940) and specifically the processors therein (including CPU, GPU, FPGA, and the like) to execute particular processes or particular parts of particular processes described herein, including defining data structures stored in RAM (946) and modifying such data structures according to the processes defined by the software. In addition or as an alternative, the computer system can provide functionality as a result of logic hardwired or otherwise embodied in a circuit (for example: accelerator (944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, the method comprising:
receiving a video bitstream for a current block, the video bitstream including flag information when (i) intra template matching prediction (intraTMP) is applied to both a luma component and a chroma component of the current block or (ii) a luma coded block flag (Cbf) indicates that the luma component of the current block is associated with zero transform coefficients, the flag information indicating whether cross-component residual model (CCRM) is applied to the current block; and
when the flag information indicates that the CCRM is applied to the current block, reconstructing chroma samples of the chroma component of the current block based on reconstructed luma samples of the luma component of the current block, the flag information including a first syntax element indicating whether the CCRM is applied to a Cb component of the chroma component and a second syntax element indicating whether the CCRM is applied to a Cr component of the chroma component.

2. The method of claim 1, wherein the video bitstream includes the flag information when:
the intraTMP is applied to both the luma component and the chroma component of the current block,
the chroma component and the luma component of the current block are in a single tree structure, and
a block vector (BV) of the chroma component is derived from a BV of the luma component.

3. The method of claim 1, wherein the reconstructing further comprises:
deriving filters based on prediction samples of the Cb component, prediction samples of the Cr component, and prediction samples of the luma component;
applying the filters to the reconstructed luma samples of the luma component to generate filtered samples of the luma component; and
reconstructing (i) samples of the Cb component based on a sum of the filtered samples of the luma component and a residual of the Cb component and (ii) samples of the Cr component based on a sum of the filtered samples of the luma component and a residual of the Cr component.

4. The method of claim 3, wherein the reconstructing further comprises:
when filter coefficients of the filters are not derivable for the Cb component, reconstructing the samples of the Cb component based on a sum of the prediction samples of the Cb component and the residual of the Cb component.

5. The method of claim 3, wherein the reconstructing further comprises:
when filter coefficients of the filters are not derivable for the Cr component, reconstructing the samples of the Cr component based on a sum of the prediction samples of the Cr component and the residual of the Cr component.

6. The method of claim 1, further comprising:
receiving transform syntax information after the flag information is received in the video bitstream, the transform syntax information indicating a transformation kernel and a quantization parameter for the current block.

7. The method of claim 1, wherein the flag information comprises respective flags for a plurality of subblocks of the current block, a flag for a subblock in the plurality of subblocks indicating whether the CCRM is applied to the subblock.

8. The method of claim 1, wherein the flag information further indicates whether the CCRM is applied to each of a plurality of subblocks of the current block.

9. A method of video encoding, the method comprising:
when (i) intra template matching prediction (intraTMP) is applied to both a luma component and a chroma component of a current block or (ii) a luma coded block flag (Cbf) indicates that the luma component of the current block is associated with zero transform coefficients, determining whether cross-component residual model (CCRM) is applied to the current block;
when the CCRM is determined to be applied to the current block, encoding chroma samples of the chroma component of the current block into a video bitstream based on reconstructed luma samples of the luma component of the current block; and
encoding flag information into the video bitstream, the flag information including a first syntax element indicating whether the CCRM is applied to a Cb component of the chroma component and a second syntax element indicating whether the CCRM is applied to a Cr component of the chroma component.

10. The method of claim 9, wherein the flag information is encoded into the video bitstream when:
the intraTMP is applied to both the luma component and the chroma component of the current block,
the chroma component and the luma component of the current block are in a single tree structure, and
a block vector (BV) of the chroma component is derived from a BV of the luma component.

11. The method of claim 9, wherein the encoding the chroma samples further comprises:
deriving filters based on prediction samples of the Cb component, prediction samples of the Cr component, and prediction samples of the luma component;
applying the filters to the reconstructed luma samples of the luma component to generate filtered samples of the luma component; and
encoding (i) samples of the Cb component based on a sum of the filtered samples of the luma component and a residual of the Cb component and (ii) samples of the Cr component based on a sum of the filtered samples of the luma component and a residual of the Cr component.

12. The method of claim 11, wherein the encoding the chroma samples further comprises:
when filter coefficients of the filters are not derivable for the Cb component, encoding the samples of the Cb component based on a sum of the prediction samples of the Cb component and the residual of the Cb component.

13. The method of claim 11, wherein the encoding the chroma samples further comprises:
when filter coefficients of the filters are not derivable for the Cr component, encoding the samples of the Cr component based on a sum of the prediction samples of the Cr component and the residual of the Cr component.

14. The method of claim 9, further comprising:
encoding transform syntax information into the video bitstream after the flag information is encoded in the video bitstream, the transform syntax information indicating a transformation kernel and a quantization parameter for the current block.

15. The method of claim 9, wherein the flag information comprises respective flags for a plurality of subblocks of the current block, a flag for a subblock in the plurality of subblocks indicating whether the CCRM is applied to the subblock.

16. The method of claim 9, wherein the flag information further indicates whether the CCRM is applied to each of a plurality of subblocks of the current block.

17. A non-transitory computer-readable storage medium storing instructions which when executed by a processor cause the processor to perform an encoding method comprising:
when (i) intra template matching prediction (intraTMP) is applied to both a luma component and a chroma component of a current block or (ii) a luma coded block flag (Cbf) indicates that the luma component of the current block is associated with zero transform coefficients, determining whether cross-component residual model (CCRM) is applied to the current block;
when the CCRM is determined to be applied to the current block, encoding chroma samples of the chroma component of the current block into a bitstream based on reconstructed luma samples of the luma component of the current block;
encoding flag information into the bitstream, the flag information including a first syntax element indicating whether the CCRM is applied to a Cb component of the chroma component and a second syntax element indicating whether the CCRM is applied to a Cr component of the chroma component; and
transmitting the encoded bitstream.

18. The non-transitory computer-readable storage medium of claim 17, wherein the flag information is encoded into the bitstream when:
the intraTMP is applied to both the luma component and the chroma component of the current block,
the chroma component and the luma component of the current block are in a single tree structure, and
a block vector (BV) of the chroma component is derived from a BV of the luma component.

19. The non-transitory computer-readable storage medium of claim 17, wherein the encoding the chroma samples further comprises:
deriving filters based on prediction samples of the Cb component, prediction samples of the Cr component, and prediction samples of the luma component;
applying the filters to the reconstructed luma samples of the luma component to generate filtered samples of the luma component; and
encoding (i) samples of the Cb component based on a sum of the filtered samples of the luma component and a residual of the Cb component and (ii) samples of the Cr component based on a sum of the filtered samples of the luma component and a residual of the Cr component.

20. The non-transitory computer-readable storage medium of claim 19, wherein the encoding the chroma samples further comprises:
when filter coefficients of the filters are not derivable for the Cb component, encoding the samples of the Cb component based on a sum of the prediction samples of the Cb component and the residual of the Cb component.
